(19) United States
(12) Patent Application Publication
(10) Pub. No.: US 2015/0058783 A1
(43) Pub. Date: Feb. 26, 2015

(54) MULTI-TOUCH SUPPORTING PARALLEL-TAPPING INPUT METHOD AND DEVICE

(71) Applicant: BORQS WIRELESS LTD., Beijing (CN)

(72) Inventors: Xiaofei Zhou, Beijing (CN); Wei Zou, Beijing (CN); Jianbing Li, Beijing (CN)

(73) Assignee: BORQS WIRELESS LTD., Beijing (CN)

(21) Appl. No.: 14/385,189

(22) PCT Filed: Nov. 2, 2012
(86) PCT No.: PCT/CN2012/083948

§ 371 Date: Sep. 15, 2014

(30) Foreign Application Priority Data
Mar. 15, 2012 (CN) 201210067767.7

(51) Int. Cl. G06F 3/0488; G06F 3/0482; G06F 3/041

(52) U.S. Cl. CPC G06F 3/04886; G06F 3/0416; G06F 3/0482; G06F 2203/04104
USPC 715/773

(57) ABSTRACT

A multi-touch supporting parallel-tapping input method comprising the following steps: obtaining multiple input operations of a user at the same time; converting the input operations of the user into characters, permuting and combining the characters, and selecting a correct character combination sequence; displaying the selected character combination sequence as a candidate character sequence in a candidate display unit for the user to select; and displaying the character combination sequence selected by the user. The method may be implemented using a multi-touch supporting virtual keyboard, so that multiple fingers can select multiple keys at the same time to perform parallel-tapping input. Through intelligent error correction, multiple keys tapped in parallel are permutated and combined to provide a candidate correct combination for a user to select, so as to improve the speed and efficiency of text inputting of the user.

### PRIORITY CLAIM

The present application is a National Phase entry of PCT Application No. PCT/CN2012/083948, filed Nov. 2, 2012, which claims priority to Chinese Patent Application No. 201210067767.7, filed Mar. 15, 2012, the disclosures of which are hereby incorporated by reference herein in their entirety.

### FIELD OF THE INVENTION

The present invention relates to an input method, in particular to a multi-touch supporting parallel-tapping input method and device.

### BACKGROUND OF THE INVENTION

In the prior art, touch screen-based input methods are widely applied in terminal units. Specifically, the user utilizes a virtual keyboard displayed on a touch screen and input Chinese characters by tapping on the virtual keys or sliding on the virtual keyboard.

In the Chinese patent document CN102117175A, a method for inputting Chinese characters by sliding and device thereof are disclosed. The method particularly comprises: capturing a sliding trajectory of the user on a virtual keyboard; obtaining the virtual key sequence involved in the sliding trajectory; screening the keys in the virtual key sequence to obtain a character input sequence; obtaining corresponding candidate Chinese characters according to the character input sequence, and displaying the candidate Chinese characters. In that invention, the user inputs Chinese characters by sliding on a virtual keyboard. In the input process, the user's fingers or a touch pen can slide directly on the virtual keyboard without leaving the virtual keyboard. Since the transition among the keys is accomplished by sliding, the user's input actions can be reduced, and the input is more consistent; thus, the input speed can be increased; in addition, a highly accurate character input sequence that meets the user's intention can be obtained by screening the keys passed by the sliding operation, and thereby candidate Chinese characters can be provided.

With the touch screen-based input method described above, the user can input only one character of phonetic spelling or only one phonetic character in one operation, but the phonetic spelling of a Chinese character usually consists of 3 or more phonetic characters. Consequently, the user has to input several times to find a Chinese character. Therefore, the input efficiency is poor, and the Chinese character input speed is severely affected.

### SUMMARY OF THE INVENTION

To overcome the drawbacks in the prior art, an object of the present invention is to provide a multi-touch supporting parallel-tapping input method and device. With multi-touch technology, the user can tap on several keys and input with several fingers at the same time to perform parallel-tapping input; thus, the soft keyboard input efficiency is improved.

To attain the object described above, an embodiment of the multi-touch supporting parallel-tapping input method of the present invention comprises the following steps:

1) obtaining multiple input operations of the user at the same time;

2) converting the input operations of the user into characters, and carrying out permutation and combination for the characters, to select correct combined character sequences;

3) displaying the selected combined character sequences as candidate character sequences on a candidate display unit, for the user to select;

4) displaying the combined character sequence selected by the user on a text display unit.

In step 1), the user's multiple input operations are obtained by a multi-touch receiving unit.

In step 2), the step of carrying out permutation and combination for the characters and selecting a correct combined character sequence is to carry out permutation and combination for the characters under the phonetic spelling rules of Chinese characters or the arrangement rules of English words.

To attain the object described above, the device that utilizes the multi-touch supporting parallel-tapping input method of the present invention comprises a multi-touch receiving unit, a touch signal processing unit, a candidate display unit, and a text display unit, wherein,

the multi-touch receiving unit is designed to receive multiple input operations from the user simultaneously;

the touch signal processing unit is designed to convert multiple key values information sent by the multi-touch receiving unit into characters, and carry out permutation and combination for the characters;

the candidate display unit is designed to display candidate character sequences for the user to select;

the text display unit is designed to display the final combined character sequence selected by the user.

In the present invention, with a virtual keyboard that supports multi-touch, the user can tap on several keys with his fingers at the same time, so as to accomplish parallel-tapping input. Through intelligent error correction, permutation and combination is carried out for the keys tapped in parallel, and thereby correct candidate character combinations are provided for the user to select. For example, to input “ [symbol] ”, the user only has to tap on b/e/i with three fingers simultaneously or asynchronously; then, the input method will provide candidate characters [symbol] , [symbol] , etc., and combinations of b/i/e, such as [symbol] , etc. In that way, input efficiency can be improved.

Hereunder other characteristics and advantages of the present invention will be described, and will become apparent partially from the description or can be understood clearly by carrying out the present invention.

### BRIEF DESCRIPTION OF THE DRAWINGS

The accompanying drawings are provided to help further understanding the present invention, and constitute a part of the description. These drawings are used in conjunction with the embodiments to interpret the present invention, but do not constitute any limitation to the present invention. Among the drawings:

FIG. 1 is a flow chart of the multi-touch supporting parallel-tapping input method according to an embodiment of the present invention;

FIG. 2 is a functional block diagram of the device that utilizes the multi-touch supporting parallel-tapping input method according to an embodiment of the present invention.

### DETAILED DESCRIPTION

Hereunder, some embodiments of the present invention will be described, with reference to the accompanying drawings. It should be understood that the embodiments described here are only provided to describe and interpret the present invention, but do not constitute any limitation to the present invention.

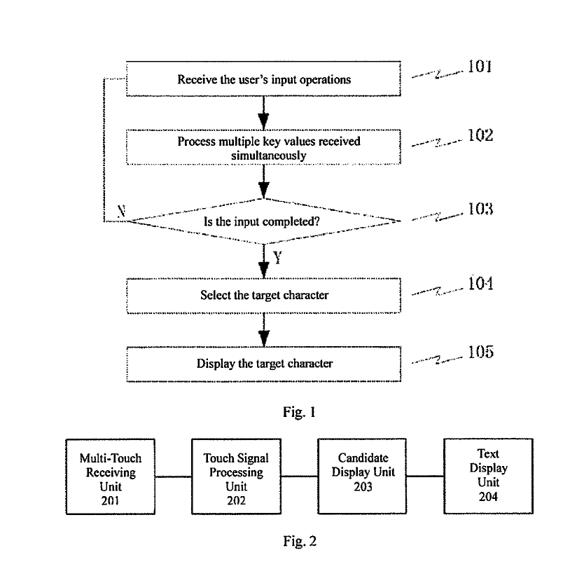

FIG. 1 is a flow chart of the multi-touch supporting parallel-tapping input method according to the present invention. Hereunder the multi-touch supporting parallel-tapping input method in the present invention will be detailed, with reference to FIG. 1:

First, in step 101, a multi-touch receiving unit 201 receives multiple input operations from the user simultaneously, and sends the signals of multiple key values to a touch signal processing unit 202 for processing;

In step 102, the touch signal processing unit 202 converts the key values signals received from the multi-touch receiving unit 201 into characters, carries out permutation and combination for the character, and selects a correct combined character sequence under the phonetic spelling rules of Chinese characters or arrangement rules of English words;

In step 103, judge whether the user's input operations have been completed; if the input operations have been completed, send the correct combined character sequences as candidate character sequences to a candidate display unit 203 for the user to select; otherwise return to step 102;

In step 104, the user selects the expected combined character sequence from the candidate display unit 203;

In step 105, a text display unit 204 displays the final combined character sequence selected by the user, and thereby the character input is completed.

The parallel-tapping input method provided in the present invention supports input by sequentially tapping on a soft keyboard and input by tapping in parallel on a soft keyboard with several fingers.

FIG. 2 is a functional block diagram of the device that utilizes the multi-touch supporting parallel-tapping input method according to the present invention. As shown in FIG. 2, the device that utilizes the multi-touch supporting parallel-tapping input method in the present invention comprises a multi-touch receiving unit 201, a touch signal processing unit 202, a candidate display unit 203, and a text display unit 204, wherein,

the multi-touch receiving unit 201 employs a virtual keyboard on a touch screen that supports multi-touch, and is designed to simultaneously receive multiple input operations (key tapping operations) from the user and send the key values information to the touch signal processing unit 202;

the touch signal processing unit 202 employs a microprocessor module, and is designed to convert the multiple key values information sent by the multi-touch receiving unit 201 into characters and carry out permutation and combination for the characters under the phonetic spelling rules of Chinese characters or arrangement rules of English words;

the candidate display unit 203 is designed to receive and display combined character sequences obtained by permutation and combination of multiple characters from the touch signal processing unit 202 for the user to select;

the text display unit 204 is connected with the candidate display unit 203 and designed to display the final user input result.

With the input method and device provided in the present invention, in a sequential-tapping input mode, the input is equivalent to conventional keyboard input; however, in a parallel-tapping input mode, the values of several keys tapped by the user can be simultaneously received, the key values are treated by permutation and combination to obtain correct combinations, and then the combinations are displayed to the user for making selection; thus, the input method and device provided in the present invention enables the user to input as fast as possible with minimum number of touches.

For example, to input “ [symbol] ”, with the existing keyboard input method, 4 touches are required, i.e., 1. touch ‘h’ key; 2, touch ‘a’ key; 3. touch ‘o’ key; 4. select [symbol] .

With the present invention, only 2 touches are required if [symbol] is inputted by parallel touching, i.e., 1. touch h/a/o keys with three fingers; 2. select [symbol] .

The multi-touch supporting parallel-tapping input method and the device that utilizes the method in the present invention are applicable to mobile terminals such as mobile phones and laptops, etc., and the touch signal processing unit 202 can utilize the microprocessor module in a mobile terminal; thus, the text input speed and efficiency can be improved.

Those skilled in the art should understand: the embodiments described above are only some preferred embodiments of the present invention, and should not be deemed as constituting any limitation to the present invention. Though the present invention is described and illustrated in detail with reference to the above embodiments, those skilled in the art can easily make modifications to the technical scheme described above in the embodiments or make equivalent replacement of some technical features. However, any modification, equivalent replacement, or refinement, without departing from the spirit and principle of the present invention, shall be deemed as falling into the protection scope of the present invention.

1. A multi-touch supporting parallel-tapping input method, comprising the following steps:
1) obtaining multiple input operations from a user at a same time;
2) converting the input operations into characters, and carrying out permutation and combination for the characters, to select correct combined character sequences;
3) displaying the selected combined character sequences as candidate character sequences on a candidate display unit, for the user to select;
4) displaying the combined character sequence selected by the user on a text display unit.

2. The multi-touch supporting parallel-tapping input method according to claim 1, wherein, in step 1), the user's multiple input operations are obtained by a multi-touch receiving unit.

3. The multi-touch supporting parallel-tapping input method according to claim 1, wherein, in step 2), the step of carrying out permutation and combination for the characters and selecting a correct combined character sequence is to carry out permutation and combination for the characters under the phonetic spelling rules of Chinese characters or the arrangement rules of English words.

4. A device that utilizes the multi-touch supporting parallel-tapping input method, comprising a multi-touch receiving unit, a touch signal processing unit, a candidate display unit, and a text display unit, wherein:
the multi-touch receiving unit is designed to receive multiple input operations from a user simultaneously;
the touch signal processing unit is configured to convert multiple key values information sent by the multi-touch receiving unit into characters, and carry out permutation and combination for the characters;
the candidate display unit is designed to display candidate character sequences for the user to select; and
the text display unit is designed to display the final combined character sequence selected by the user.

5. The device that utilizes the multi-touch supporting parallel-tapping input method according to claim 4, wherein, the multi-touch receiving unit is a multi-touch supporting virtual keyboard.

6. A mobile terminal that utilizes a multi-touch supporting parallel-tapping input method, wherein, the mobile terminal includes the device of claim 4.

7. The mobile terminal of claim 6, wherein the multi-touch supporting parallel tapping input method comprises the following steps:
1) obtaining multiple input operations from a user at a same time;
2) converting the input operations into characters, and carrying out permutation and combination for the characters, to select correct combined character sequences;
3) displaying the selected combined character sequences as candidate character sequences on a candidate display unit, for the user to select;
4) displaying the combined character sequence selected by the user on a text display unit.
